(19) United States
(12) Patent Application Publication
(10) Pub. No.: US 2018/0312418 A1
(43) Pub. Date: Nov. 1, 2018

(54) RECOVERY AND TREATMENT OF WATER HARVESTED FROM RAIN AND CLIMATE CONTROL EQUIPMENT

(71) Applicants: Chad Martin, Los Altos, CA (US); Robert Joseph Wieland, Rolling Hills Estates, CA (US)

(72) Inventors: Chad Martin, Los Altos, CA (US); Robert Joseph Wieland, Rolling Hills Estates, CA (US)

(73) Assignee: DripCycle, LLC, Mountain View, CA (US)

(21) Appl. No.: 15/582,328

(22) Filed: Apr. 28, 2017

(51) Int. Cl. C02F 9/00; F24F 13/22; C02F 1/00

(52) U.S. Cl. CPC C02F 9/00; F24F 13/222; C02F 1/008; C02F 1/78; F24F 2013/228; C02F 2201/005; F24F 2013/227

(57) ABSTRACT

An apparatus, method, and system may recover and treat harvested water that is produced by metrological precipitation or condensation from climate control equipment. To reduce the cost, the system and apparatus may comprise no more than one pump (10). A pump (10) may be configured by a valve (11) having at least a first position that evacuates the collected water, and a second position that circulates the collected water through a sanitation unit (18) and then back into a collector (6). The sanitation unit (18) may comprise a filter unit (12), an ultraviolet unit (13), and an ozone unit (14).

### FIELD OF TECHNOLOGY

This disclosure relates generally to the recovery, treatment, and reuse of condensate and meteorological precipitation. More specifically to the recovery, treatment, and reuse of rainwater and condensate from climate control equipment.

### BACKGROUND

In the continental United States the average amount of moisture falling as rain and snow is about 30 inches per year. In a region of average humidity a 4 ton central air conditioner unit may produce a half a gallon of condensate per hour. Capturing and reusing water harvested from climate control equipment and rainwater are responsible ways to reuse a limited natural resource. However, condensate and rainwater (together “harvested water”) may contain biological or chemical contamination so treatment may be necessary before use.

Organic contamination of harvested water may be treated with a variety of equipment and methods. Some treatment systems may use chlorine as a chemical disinfectant. Two alternatives to chlorine are ozone bubbles and ultraviolet (UV) light, both of which have an anti-microbiological effect on waterborne organisms. Another alternative is filtering, which may be used to remove some waterborne organisms.

The cost of water in the United States is on the order of 50 cents per 100 gallons. The cost of water harvesting equipment should therefore be kept low. Pumps are a major cost contributor and are a potential point of failure so systems with few pumps are economically advantageous.

Therefore, it is an object of this invention to provide for the in situ capture and treatment of harvested water produced by climate control equipment and meteorological precipitation. It is further an object of this invention to provide for the reuse of harvested water by treating it with a sanitation unit. It is yet another object of this invention to provide an effective, reliable, low cost apparatus for the reuse of harvested water.

### SUMMARY

In one or more embodiments a method, apparatus, or system may collect, treat, and reuse harvested water that is produced by meteorological precipitation and climate control equipment. The apparatus and system may comprise an ozone unit that is configured to mix bubbles of the ozone containing gas into the harvested water. The method, apparatus and system may further comprise an ultraviolet light source that is configured to irradiate the harvested water. The method, apparatus and system may further comprise no more than one pump. The method, apparatus and system may further comprise a valve having at least a first position and a second position, wherein the first position circulates the harvested water through a sanitation unit and the second position evacuates the harvested water from the system.

Other embodiments will be apparent from the following description and the appended claims.

### BRIEF DESCRIPTION OF THE DRAWINGS

Example embodiments are illustrated by way of example and not limitation in the figures of accompanying drawings, in which like references indicate similar elements and in which:

FIG. 1 is a block diagram illustrating one embodiment of the water treatment method.

FIG. 2 is a block diagram illustrating the harvested water treatment system, apparatus and method in a first embodiment.

FIG. 3 is a block diagram illustrating the harvested water treatment system, apparatus and method in a second embodiment.

FIG. 4 is a block diagram illustrating the harvested water treatment system, apparatus and method in a third embodiment.

FIG. 5 is a block diagram illustrating the harvested water treatment system, apparatus and method in a fourth embodiment.

Other features of the embodiments will be apparent from the accompanying Drawings and from the Detailed Description that follows.

### DETAILED DESCRIPTION

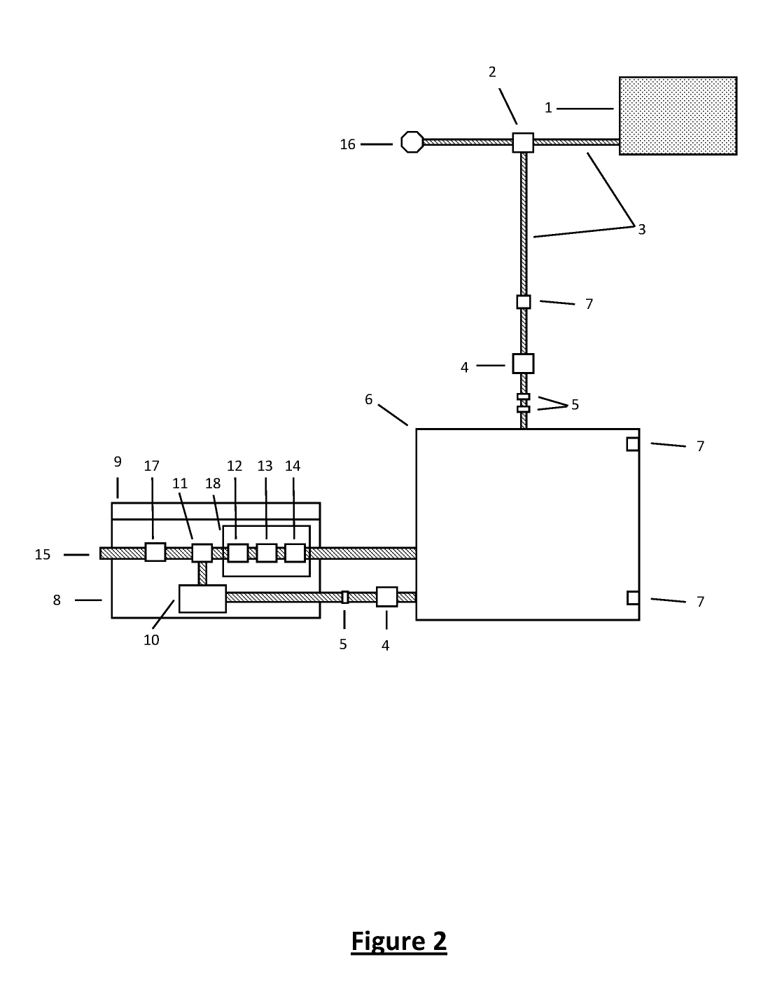

In one embodiment (e.g. FIG. 2) a method, apparatus, or system for the collection, treatment, and reuse of harvested water may comprise one or more: catch units 1 (e.g. air conditioning condensate catch, heating condensate catch, ventilation condensate catch, humidifier condensate catch, refrigerator condensate catch, or meteorological precipitation catch) that produce or catch harvested water, valves 2+11, piping 3, strainers 4, pipe joints 5, collectors 6 (e.g. tanks), sensors 7, enclosures 8, electronic control units 9, drains 16, pumps 10, sanitation units 18, ultraviolet units 13, filter units 12, meters 17, ozone units 14, and outflows 15. Catch units 1 may produce or catch harvested water when moist air experiences a drop in temperature. Catch units 1 may also catch harvested water produced by meteorological precipitation (e.g. drizzle, rain, sleet, snow, graupel, hail, and dew). Harvested water may be directed to a drain 16 or may be collected in a collector 6. Valves 2+11 may be used to direct or control the flow of the harvested water and the collected water through piping 3 and pipe joints 5. Strainers 4 and filter units 12 may separate debris, particles, or waterborne organisms from the harvested water. Sensors 7 and meters 17 may detect, prevent, alter, manage, or measure: an overflow of the collector 6, a fluid or gas pressure, a fluid level or depth, a presence of a gas or a fluid, a fluid or gas flow or velocity, an electrical conductivity of a gas or fluid, a pH of fluid, an ozone or gas content, a light refraction in a gas or fluid, or another property of gas or fluid. An enclosure 8 may enclose the apparatus or a portion of the apparatus. System electronics 9 may actuate valves 2+11, control pumps 10, receive sensor 7 data, or control units within the system (e.g. enable and disable a sanitation unit 18, enable and disable an ultraviolet unit 13, enable and disable an ozone unit 14). System electronics 9 may also time events, collect other data, interact with users, produce alarms, provide power, and control the apparatus. In order to simplify the Drawings, the electrical control wires and connections are not shown in the Drawings. Drains 16 may use gravity to drain a liquid. Pumps 10 may use mechanical action to move the harvested water, collected water, or another fluid. Ultraviolet units 13 that produce ultraviolet light at wavelengths near 254 nm may be used for anti-microbial effect. Ozone units 14 may produce ozone containing gas and may inject the ozone containing gas in the collected water or a portion of the collected water. The collected water may be evacuated from the system through an outflow 15 so the water may be used elsewhere.

In one embodiment, a single pump 10 may provide at least three features in the apparatus, system, or method. First, the single pump 10 may evacuate, through the outflow 15, some or all of the collected water of the apparatus or system. Thus, the single pump 10 may turn some or all of the collected water into evacuated water that leaves the apparatus or system. Second, the single pump 10 may sanitize some or all of the collected water. Here the single pump 10 may move some or all of the collected water through a sanitation unit 18 that neutralizes microbes and other organic impurities in the moving water. For example, the sanitation unit 18 may comprise an ultraviolet unit 13 that irradiates the moving water, an ozone unit 14 that introduces ozone into the moving water, or a filter unit 12 that filters the moving water. Third, the single pump 10 may circulate some or all of the water back into the collector. Thus, the single pump 10 may mix some or all of the sanitized water back into the water in the collector.

In another embodiment, a single pump 10 may provide at least two of the features discussed above. For example, the single pump may provide the sanitation feature and the circulation feature while the evacuation feature is provided by gravity.

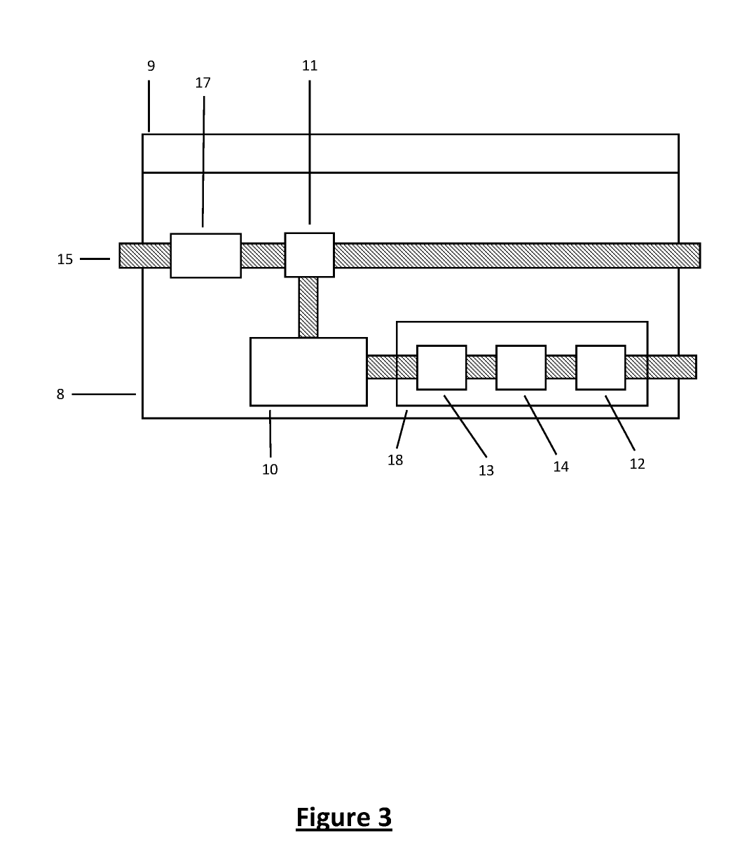

In one embodiment, a valve 11 having at least two positions may configure a pump 10 of the apparatus, method or system. In a first position, the valve 11 may allow the collected water to flow through the pump 10 and exit through the outlet 15. In a second position, the valve 11 may allow the collected water to flow through the pump 10, through a sanitation unit 18, and back into the collector 6. The first and second valve positions may also allow the collected water to flow elsewhere in the apparatus or system. For example, the first position of the valve 11 may allow a portion of the collected water to flow through a portion of the sanitation unit 18 before that portion of the collected water is evacuated through the outlet 15. See e.g. FIGS. 3-5.

In another embodiment, a valve 11 having an open position and a closed position may allow the collected water to exit through the outlet 15 via gravity. In this embodiment, the collected water may flow through the sanitation unit 18 and back into the collector 6 without flowing through the valve 11. Here too, the collected water may exit through the outlet 15 without flowing through the pump 10.

In one embodiment, the apparatus or system may comprise a sanitation unit 18 that neutralizes microbes and other organic impurities in the collected water. The sanitation unit 18 may comprise a filter unit 12 that removes impurities from the collected water by at least one of: a fine physical barrier, a chemical process, or a biological process. The filter unit 12 may remove impurities from the collected water as the collected water is passed through the filter unit 12. Alternatively, or in addition, the sanitation unit 18 may comprise an ultraviolet unit 13. The ultraviolet unit 13 may irradiate the collected water with ultraviolet light as the collected water is passed through the ultraviolet unit 13. Alternatively, or in addition, the sanitation unit 18 may comprise an ozone unit 14. The ozone unit 14 may introduce ozone into the collected water as the collected water is passed through the ozone unit 14.

In one embodiment, the method, apparatus or system may comprise a sanitation unit 18 comprising a filter unit 12, an ultraviolet unit 13, and an ozone unit 14 wherein the collected water may pass through these three units in any order. In one embodiment, the apparatus or system may comprise a sanitation unit 18 wherein the collected water may leave the collector 6 and pass through a filter unit 12 before an ultraviolet unit 13, and pass through the ultraviolet unit 13 before an ozone unit 14. After leaving the collector 6, the collected water may enter a filter unit 12 before an ultraviolet unit 13, and enter the ultraviolet unit 13 before an ozone unit 14. The ultraviolet unit 13 may follow the filter unit 12 and precede the ozone unit 14 because turbidity may decrease the effectiveness of the ultraviolet unit 13. In turbid water, suspended particles may shield some microorganisms from the UV light and thus some microorganisms may pass through the UV unit unaffected. In this aspect, the filter unit 12 may generally decrease turbidity by removing impurities and the ozone unit 14 may generally increase turbidity by introducing ozone to the water. Furthermore, in this aspect, the ozone unit 14 may follow the filter unit 12 because the filter unit 12 may impede the circulation of the ozone within the water of the collector 6. Alternatively, the filter unit 12 may follow the ozone unit 14 because the filter unit 12 may break the ozone bubbles into smaller, more persistent bubbles.

In one embodiment, an ozone unit 14 may produce ozone containing gas. Ozone, when introduced into the collected water, may neutralize microbial contamination in the collected water. The ozone containing gas may be produced by corona discharge, ultraviolet radiation, electrolysis, and radiochemical methods. Corona discharge is created when a high voltage passes through an air gap. The high voltage provides the energy to disassociate some of the O2 molecules in the air gap and so facilitates the formation of ozone. Ultraviolet radiation at wavelengths less than 240 nm (e.g. near 185 nm) may be used to create ozone by disassociating O2 molecules, and ultraviolet radiation may also be used to destroy ozone at wavelengths less than 290 nm (e.g. near 254 nm). Electrolysis produces ozone when an electric current is passed through a liquid (e.g. the collected water) causing the evolution of ozone containing gas. In electrolysis, an ion exchange membrane may function as both an electrode separator and electrolyte.

In one embodiment, an ozone unit 14 may produce an ozone containing gas using the ultraviolet light of the ultraviolet unit 13. The ultraviolet unit may produce ultraviolet light at a plurality of wavelengths so that an oxygen-containing gas (e.g. air) may be passed near the light source to produce an ozone-containing gas (e.g. air having ozone). The ozone-containing gas may then be introduced into the moving water before, after, or while the moving water is irradiated by passing near the same light source.

In one embodiment, the ozone unit 14 may introduce an ozone containing gas into the collector 6 or the collected water. The ozone unit 14 may introduce the ozone containing gas into the collected water before, after, or while the collected water moves through a pump 10. The ozone unit 9 may introduce bubbles of ozone containing gas into the collected water. The bubbles may have a preferred diameter of less than one of: 100 microns, 50 microns, 10 microns, 2 microns, 1 micron, 0.5 microns, and 0.2 microns. Larger bubbles are less persistent and less effective than smaller bubbles.

In one embodiment, the harvested water or collected water may be essentially free of chlorine. In such an embodiment, the apparatus and system may be free of a chlorination unit that would otherwise introduce chlorine into the collected water.

In one embodiment, the ozone unit 14 may comprise a porous diffuser. For example, the ozone unit 14 may comprise a porous polymer, ceramic, stone, silica, or another material with fine pores. Ozone containing gas may move through the porous diffuser to break the ozone containing gas into small bubbles. In one embodiment the ozone unit 14 may comprise a mechanical actuator configured to move the collected water at a high shear rate relative to the gas. The high shear rate is used to break the gas into small bubbles. For example, the ozone unit 14 may comprise an atomizer, or another mechanical apparatus that combines liquid and gas at a high speed. Such an atomizer may comprise a vibrating element, oscillator, or another apparatus for pulsing the liquid or gas to cause the gas to form small bubbles. Such an atomizer may comprise rotating elements for shearing the gas in to small bubbles. In one embodiment the ozone unit 14 may comprise a nozzle configured to combine the collected water and gas at a high relative shear rate. For example, the ozone unit 14 may comprise a spray nozzle, spew-nozzle, diffuser, or Venturi apparatus. In one embodiment the ozone unit 14 may comprise a mechanical actuator configured to pressurize a portion of the collected water and an injector configured to inject the gas into the pressurized portion of the collected water. For example, the ozone unit 14 may comprise a unit that applies an increased pressure on a portion of the liquid and injects the gas into the pressurized portion of the liquid. Such a unit may comprise a pump. In one embodiment the ozone unit 14 may comprise an injector configured to inject the bubbles having a second diameter that is greater than the first diameter and an agitator configured to abruptly break the bubbles having the second diameter into the bubbles having the first diameter. For example, the agitator may comprise ridges, walls, vortex features, turbulence features, a pump, a vibrator, an oscillator, an agitator, a nozzle, a Venturi apparatus, or another mixing apparatus. In one embodiment the ozone unit 14 may comprise an electrolysis unit having an anode and cathode. Such an electrolysis unit may be configured to pass an electric current through the anode and cathode.

In one embodiment, the moving water may leave the collector 6 and enter the ozone unit 14 before moving through the pump 10. In this embodiment the pump 10 may agitate the ozone bubbles introduced by the ozone unit 14 and in this way break the ozone bubbles into smaller, more persistent ozone bubbles. See e.g. FIG. 3. In one embodiment, the moving water may leave the collector 6 and enter the ultraviolet unit 13 before moving through the pump 10. See e.g. FIGS. 3-5.

In one embodiment, an ultraviolet unit 13, may emit light in the ultraviolet-C spectrum which has wavelengths between 200 and 290 nm. Ultraviolet light in this spectrum may neutralize microorganisms (i.e. microbes) by destroying nucleic acids and disrupting microbial DNA. Ultraviolet light in this spectrum (e.g. <290 nm) may also disassociate ozone, briefly forming hydrolyl radicals (.OH) which act as very strong oxidants. Ozone in the presence of UV radiation may increase the ozonation rate of organic substances by 10 to 10,000 times the rate of ozone alone. In one embodiment, the sanitation unit 18 may comprise an ozone unit 14 which suspends ozone in the collected water, and an ultraviolet unit 13 which irradiates the collected water and the suspended ozone with ultraviolet light. In this embodiment, the ultraviolet light may neutralize microorganisms and, in the presence of ozone, produce hydroxyl radicals that neutralize (e.g. mineralize) a substantial portion of all dissolved organic matter, including persistent compounds that are hard to remove such as pesticides and gasoline additives.

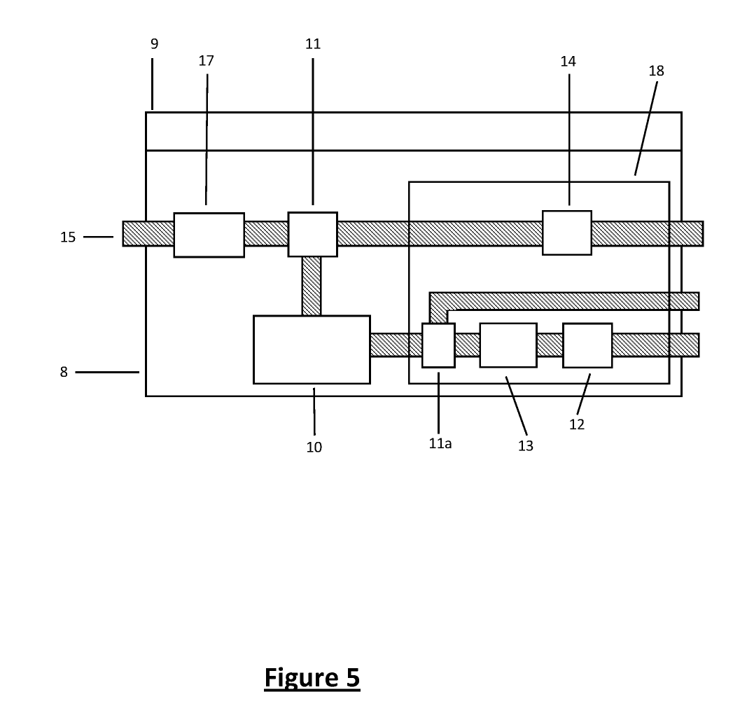

In one embodiment, the moving water may leave the collector 6 and enter an ozone unit 14 before an ultraviolet unit 13 in order to promote production of hydroxyl radicals. In one embodiment, the moving water may leave the collector 6 and enter an ultraviolet unit 13 before an ozone unit 14 to increase the concentration of ozone that returns to the collector (e.g. to disinfect the collector). In one embodiment, an electronic control unit 9 may disable an ultraviolet unit 13 and enable an ozone unit 14 to increase the concentration of ozone that returns to the collector (e.g. to disinfect the collector). In one embodiment, an electronic control unit 9 may actuate at least one bypass valve 11a so that the moving water bypasses an ultraviolet unit 13. See e.g. FIG. 5. The ultraviolet unit 13 may be bypassed or disabled so that an ozone unit 14 may increase the concentration of ozone in the water circulating through the collector (e.g. to disinfect the collector). In this aspect, an electronic control unit 9 may directly disable, or disable by bypassing, an ultraviolet unit 13 because the ultraviolet unit 13 may otherwise act to decrease the concentration of ozone in the collected water as the collector water circulates through the sanitation unit 18. In another embodiment, an electronic control unit 9 may directly disable, or disable by bypassing, an ozone unit 14 and enable an ultraviolet unit 13 in order to decrease the concentration of ozone in the collected water before the collector water is evacuated from the apparatus through the outflow 15. A first valve position of a valve 11 may enable a portion of the collected water to flow through the ultraviolet unit 13 as that portion of the collected water is evacuated from the apparatus through the outflow 15. See e.g. FIGS. 3-5. Here the ultraviolet unit 13 may decrease the concentration of ozone in the collected water as the collector water is evacuated from the apparatus through the outflow 15. Thus, in one embodiment, an electronic control unit 9 may be capable of controlling an ozone unit 14 and an ultraviolet unit 13 such that one of: the ozone unit 14 is enabled while the ultraviolet unit 13 is disabled; and the ozone unit 14 is disabled while the ultraviolet unit 13 is enabled.

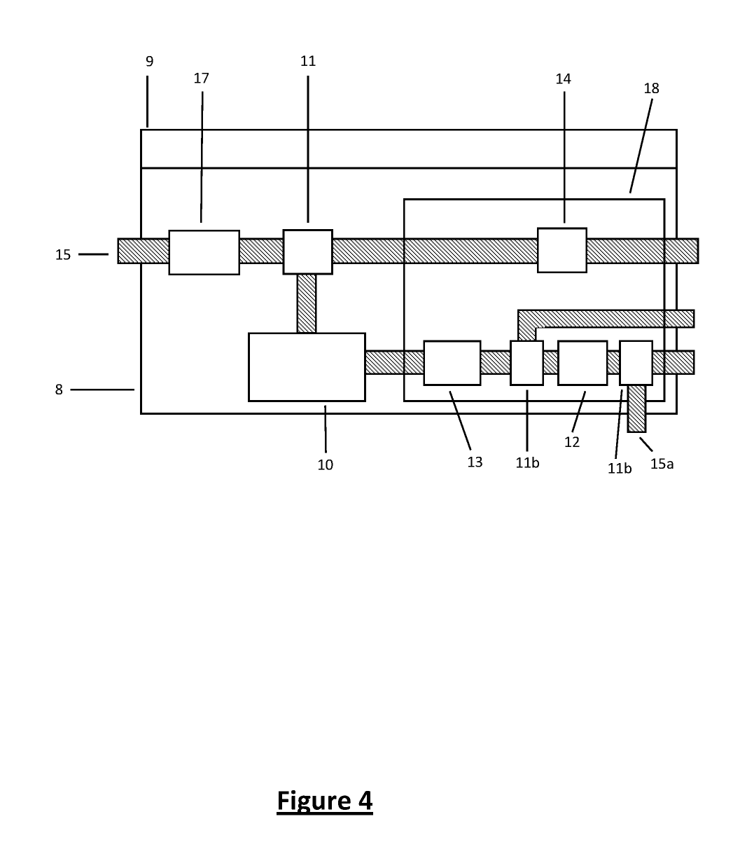

In one embodiment a sanitation unit 18 may comprise a filter 12 that may neutralize a waterborne microbe. In one embodiment, an electronic control unit 9 may control one or more backflush valves 11b that in a first position direct water from the collector 6 through the filter 12 in a normal direction, and in a second position direct water from the collector 6 through the filter 12 backwards from the normal direction and then out of the apparatus through a backflush outlet 15a. See e.g. FIG. 4.

In one embodiment, the electronic control unit 9 may be housed in a lid of the enclosure 8. See e.g. FIG. 2 which is an elevation view. The electronic control unit 9 may comprise a controller that controls the valve 11, pump 10, and sanitation unit 18. The lid of the enclosure 9 is defined as the top covering of the enclosure and may be hinged or removable. Housing the electronic control unit 9 in an enclosure lid may elevate the unit's electronic components above the valve 11, pump 10, or sanitation unit 18 so the danger of water from these elements intruding into the electronic control unit 9 is minimized. Housing the electronic control unit 9 in an enclosure lid may also elevate the unit's electronic components above moisture (e.g. rain) that may seep into the enclosure from outside the enclosure.

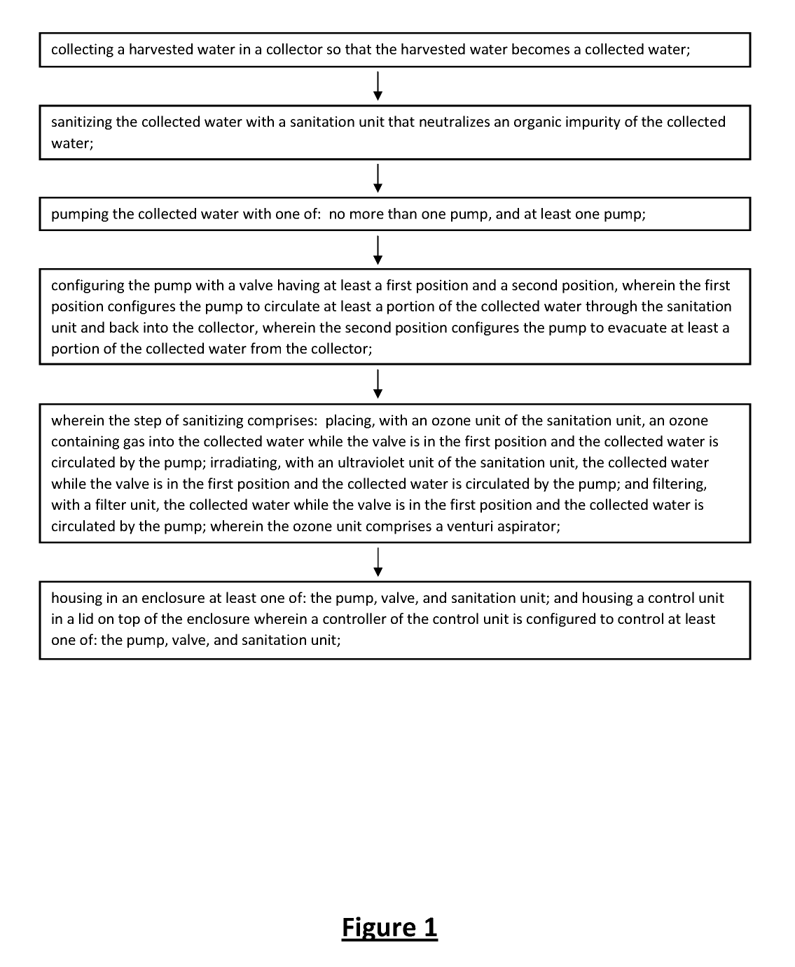

FIG. 1 illustrates the steps comprising one embodiment of a method for in situ collection and treatment of harvested water produced by at least one of: meteorological precipitation and climate control equipment condensation.

The invention is not limited to the particular embodiments described. The terminology used herein is for the purpose of describing particular embodiments only, and is not intended to be limiting. Though any methods and materials similar or equivalent to those described herein can also be used in the practice or testing of the present invention, a limited number of the exemplary methods and materials are described herein.

Where a range of values is provided, each intervening value in that stated range is encompassed within the invention. Smaller ranges embodied by a stated range are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. The singular forms “a”, “an”, and “the” include plural referents unless the context clearly dictates otherwise. In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. An apparatus for in situ collection and treatment of a harvested water produced by at least one of: meteorological precipitation and climate control equipment condensation, the apparatus comprising:
a collector configured to collect the harvested water so that the harvested water becomes a collected water;
a sanitation unit configured to neutralize an organic impurity of the collected water; and
no more than one pump configured to pump the collected water.

2. The apparatus of claim 1, further comprising a valve having at least a first position and a second position, wherein the first position configures the pump to circulate at least a portion of the collected water through the sanitation unit and back into the collector, wherein the second position configures the pump to evacuate at least a portion of the collected water from the apparatus.

3. The apparatus of claim 2, wherein the sanitation unit comprises: an ozone unit configured to introduce an ozone containing gas into the collected water while the valve is in the first position and the collected water is circulated by the pump, an ultraviolet unit configured to irradiate the collected water with ultraviolet light while the valve is in the first position and the collected water is circulated by the pump, and a filter unit configured to filter the collected water while the valve is in the first position and the collected water is circulated by the pump.

4. The apparatus of claim 3, wherein the ozone unit comprises a venturi aspirator.

5. The apparatus of claim 4, further comprising a lid on top of an enclosure, wherein the enclosure houses at least one of: the pump, valve, and sanitation unit, wherein the lid houses a control unit having a controller configured to control at least one of: the pump, valve, and sanitation unit.

6. An apparatus for in situ collection and treatment of a harvested water produced by at least one of: meteorological precipitation and climate control equipment condensation, the apparatus comprising:
a collector configured to collect the harvested water so that the harvested water becomes a collected water;
a sanitation unit configured to neutralize an organic impurity of the collected water;
at least one pump configured to pump the collected water; and
a valve having at least a first position and a second position, wherein the first position configures the pump to circulate at least a portion of the collected water through the sanitation unit and back into the collector, wherein the second position configures the pump to evacuate at least a portion of the collected water from the apparatus.

7. The apparatus of claim 6, wherein the sanitation unit comprises: an ozone unit configured to place an ozone containing gas into the collected water while the valve is in the first position and the collected water is circulated by the pump.

8. The apparatus of claim 7, wherein the sanitation unit further comprises: an ultraviolet unit configured to irradiate the collected water with ultraviolet light while the valve is in the first position and the collected water is circulated by the pump, and a filter unit configured to filter the collected water while the valve is in the first position and the collected water is circulated by the pump.

9. The apparatus of claim 8, wherein the ozone unit comprises a venturi aspirator.

10. The apparatus of claim 9, further comprising a lid on top of an enclosure, wherein the enclosure houses at least one of: the pump, valve, and sanitation unit, wherein the lid houses a control unit having a controller configured to control at least one of: the pump, valve, and sanitation unit.

11. A method for in situ collection and treatment of a harvested water produced by at least one of: meteorological precipitation and climate control equipment condensation, the method comprising:
collecting the harvested water in a collector so that the harvested water becomes a collected water;
sanitizing the collected water with a sanitation unit that neutralizes an organic impurity of the collected water; and
pumping the collected water with no more than one pump.

12. The method of claim 11, further comprising the step of: configuring the pump with a valve having at least a first position and a second position, wherein the first position configures the pump to circulate at least a portion of the collected water through the sanitation unit and back into the collector, wherein the second position configures the pump to evacuate at least a portion of the collected water from the collector.

13. The method of claim 12, wherein the step of sanitizing comprises: placing, with an ozone unit of the sanitation unit, an ozone containing gas into the collected water while the valve is in the first position and the collected water is circulated by the pump; irradiating, with an ultraviolet unit of the sanitation unit, the collected water while the valve is in the first position and the collected water is circulated by the pump; and filtering, with a filter unit, the collected water while the valve is in the first position and the collected water is circulated by the pump.

14. The method of claim 13, wherein the ozone unit comprises a venturi aspirator.

15. The method of claim 14, further comprising: housing in an enclosure at least one of the pump, valve, and sanitation unit; and housing a control unit in a lid on top of the enclosure wherein a controller of the control unit is configured to control at least one of: the pump, valve, and sanitation unit.

16. A method for in situ collection and treatment of a harvested water produced by at least one of: meteorological precipitation and climate control equipment condensation, the method comprising:
collecting the harvested water in a collector so that the harvested water becomes a collected water;
sanitizing the collected water with a sanitation unit that neutralizes an organic impurity of the collected water;
pumping the collected water with at least one pump; and
configuring the pump with a valve having at least a first position and a second position, wherein the first position configures the pump to circulate at least a portion of the collected water through the sanitation unit and back into the collector, wherein the second position configures the pump to evacuate at least a portion of the collected water from the collector.

17. The method of claim 16, wherein the step of sanitizing comprises placing, with an ozone unit of the sanitation unit, an ozone containing gas into the collected water while the valve is in the first position and the collected water circulates.

18. The method of claim 17, wherein the step of sanitizing further comprises: irradiating, with an ultraviolet unit of the sanitation unit, the collected water while the valve is in the first position and the collected water is circulated by the pump; and filtering, with a filter unit, the collected water while the valve is in the first position and the collected water is circulated by the pump.

19. The method of claim 18, wherein the ozone unit comprises a venturi aspirator.

20. The method of claim 19, further comprising: housing in an enclosure at least one of the pump, valve, and sanitation unit; and housing a control unit in a lid on top of the enclosure wherein a controller of the control unit is configured to control at least one of: the pump, valve, and sanitation unit.
